(19) United States
(12) Patent Application Publication
(10) Pub. No.: US 2010/0176648 A1
(43) Pub. Date: Jul. 15, 2010

(54) Method Of Producing A Support Pin Component

(75) Inventors: Andreas Häntsch, Hannover (DE); Heiner Kempf, Hannover (DE)

Correspondence Address: ROBERT W. BECKER & ASSOCIATES, 707 HIGHWAY 333, SUITE B, TIJERAS, NM, 87059-7507, US

(73) Assignee: Faurecia Autositze GmbH, Stadthagen (DE)

(21) Appl. No.: 12/529,770

(22) PCT Filed: Feb. 28, 2008
(86) PCT No.: PCT/DE08/00349

§ 371 Date: Mar. 23, 2010

(30) Foreign Application Priority Data
Mar. 3, 2007 (DE) 10-2007-062-784.1
Mar. 3, 2007 (DE) 10-2007-010373.7

(51) Int. Cl. B60N 2/30; B21D 31/00

(52) U.S. Cl. 297/463.1; 72/379.2

(57) ABSTRACT

A method of producing a support pin component for attachment to a reclining part of a vehicle seat and for insertion into a support receiver of a seat frame. The support pin component has an attachment region for attachment to the reclining part of the vehicle seat, and a pin for the pivotable insertion into a support receiver of the seat frame. The support pin component is produced as a shaped part of sheet steel, for example in a progressive composite process.

The present invention relates to a method of producing a support pin component, and to a support component produced by this method.

With vehicle seats having pivotable and/or foldable backrests, the reclining axis is generally formed by a bolt that is formed on the reclining part and that is inserted into a support receiver or a support eye of the seat frame. This support attachment must be adequately stable in order to be able to absorb the forces that occur during normal travel, and suplementarily the high forces that occur during a possible crash.

For this purpose, generally a cold pressed and subsequently hot forged component is used that has an elongated attachment region and a bolt or pin, whereby the elongated attachment region is welded onto the reclining part or its structure, and the pin extends outwardly from the attachment region and has an internal thread into which is threaded a screw. This projecting pin with inserted screw thus serves as a support pin for defining the pivot axis.

Such cold pressed and forged components of steel are adequately rigid in order to absorb the required forces and movements. However, they are very expensive to produce and are furthermore relatively heavy.

DE 101 33 708 C1 shows a mounting system for a divided motor vehicle back seat rest where two reclining parts and a central part disposed between them are connected by a support pin that has an adequately long pin shaft, whereby two spaced-apart recesses are formed on its free end.

CH 639 178 A shows a self-securing support pin for the securement against axial displacement during the installation into machine components, and is produced from a bent sheet strip. A hollow, tubular pin is formed in this fashion into which elongated slots can be formed.

The object of the present invention is to provide a method of producing a support pin component that along with low manufacturing costs enables a reliable support attachment and a low overall weight.

This object is realized by a method according to claim 1. The dependent claims describe preferred further developments. In this connection, supplementarily the inventively produced support pin component is provided.

Thus, pursuant to the present invention a manufacturing process is provided with which the support pin component is produced not as a cold pressed and forged component, but rather as a shaped part of sheet metal. In so doing it can have a lighter configuration and can be produced at lower cost.

The support pin component is advantageously produced as a monolithic or one-piece shaped sheet metal component, whereby not only the pin but also the attachment region can be produced by a shaping or deformation process with a plurality of successive process steps. By means of such a cold shaping or deformation, the strength of the sheet steel is increased, so that at the conclusion it has a high strength for receiving the forces and moments that act on it.

For the production, a starting sheet can be unwound directly from the coil of an adequately deformable, ductile, economical steel, and can be shaped or deformed in a plurality of process steps. For this purpose, preferably also the pin is monolithically formed from the steel material without a weld seam, and correspondingly the rear attachment region is formed in the desired thickness. To form the pin as a tube or a tubular extension, a tube drawing technology can be utilized, according to which first a cup or bowl is drawn into the starting sheet in a plurality of successive process steps, and the thus-formed tube is subsequently deformed or swaged in a plurality of process steps. During this manufacture, a progressive composite process can be used according to which the starting sheet is pushed through a progressive composite tool in individual steps until the desired shapes or profilings are achieved in the successive shaping or deformation steps; in the last operation, the components are separated from the sheet strip.

Pursuant to the present invention, an axial follow-up or release of the material of the starting sheet is advantageously carried out in order to prevent a thinning out of the tube wall or to achieve the desired thickness, which is subsequently further enlarged by swaging or deformation.

The welding can, for example, be effected by CO2 welding or also by laser welding. For the laser welding, one or more flanges are advantageously provided on the underside of the attachment region. For example, a forward flange can serve for the attachment to the outer support of the reclining part, and a rear flange can serve for the attachment to an inner sheet plate or a transverse support of the reclining part.

The invention will be explained in detail in the following with the aid of one embodiment, which is shown in the accompanying drawings and in which:

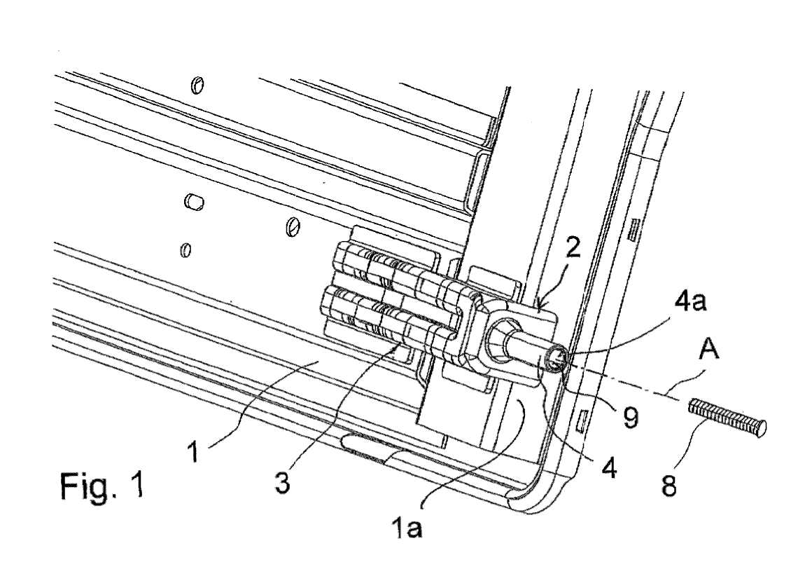

FIG. 1: is a perspective view of a reclining part having a support pin component attached thereto;

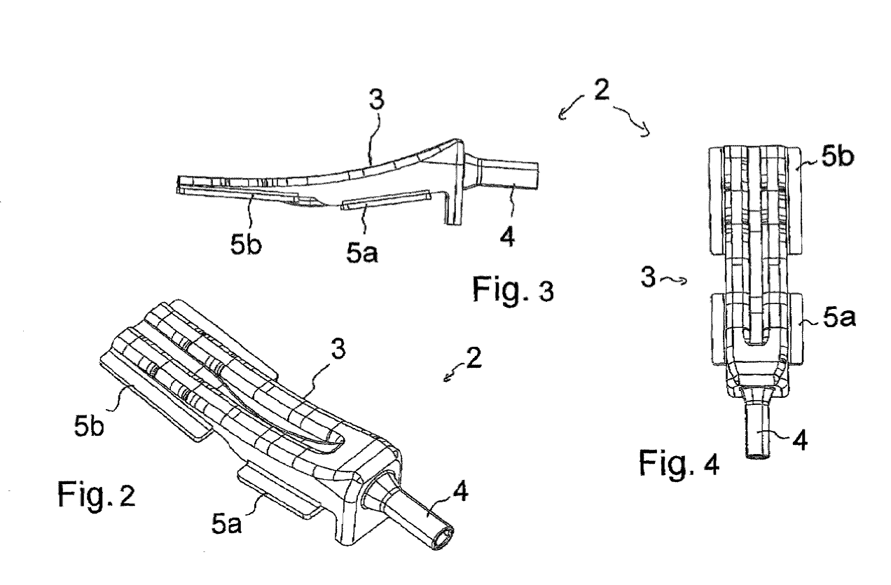

FIG. 2: is a further perspective view of the support pin component;

FIG. 3 is a side view of the support pin component;

FIG. 4 is a top view of the support pin component;

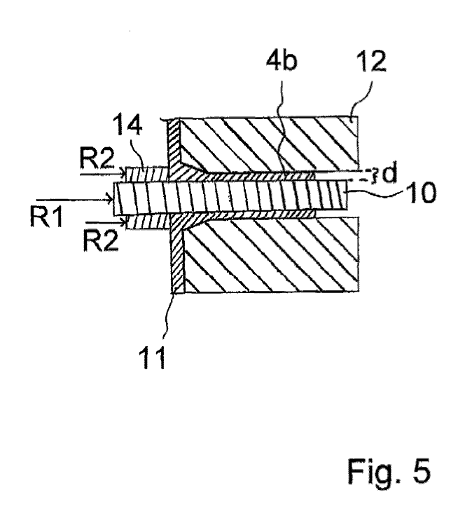

FIG. 5 is an axial section through the tube during the production of the pin.

A reclining part 1 of a vehicle seat is pivotably mounted to a seat frame, which is not shown in the figures. The reclining part 1 can in particular be a backrest, or also e.g. a storage means or some other foldable functional reclining element, for example having a table function.

The reclining part 1 is mounted to the seat frame so as to be pivotable in a reclining axis A which is defined by a support or bearing pin or bolt component 2, and by a support or bearing receiver (support eye) that is formed on the seat frame, receives the support pin component 2, and is here not illustrated.

The support pin component 2 is provided with a rear attachment region 3 and a forward pin or bolt 4. The attachment region 3 serves for the attachment to the reclining part 1. The pin 4 extends in a lateral direction—along the axis A—and laterally outwardly for insertion into the support receiver of the seat frame.

Pursuant to the present invention, the support pin component 2 is embodied as a one-piece or monolithic sheet metal shaped part of steel. Supplementarily, laterally projecting flanges 5a, 5b can be secured to the underside of the attachment region 3 in order to enable a mounting attachment on the reclining part 1 by means of laser welding. In this connection, for example, a forward flange 5a can be provided for placement on a vertical support of the reclining part 1, and a rear flange 5b can be provided for placement on a central sheet or a transverse support of the reclining part 1. In principle, however, the support pin component 2 can also be configured without these flanges 5a, 5b, and can be attached to the reclining part 1 by, for example, CO2 welding.

As can be seen, for example, in FIG. 3, the attachment region 3 advantageously increases continuously in height toward the pin 4. At its right, forward end the attachment region 3 is placed upon an edge la of the vertical support of the reclining part 1, where it is attached by means of a vertical weld. The pin 4, for example in its rear region, is initially somewhat conical, and its forward region has a tubular configuration. The pin has a hole or bore 4a with an internal thread 9 for receiving a screw 8 that, in a manner known per se, is inserted into the support receiver of the seat frame. The screw 8 is illustrated schematically.

The manufacture of the inventive support pin component 2 is effected by a multi-stage shaping or deformation process. In this connection, a progressive composite process is used according to which a starting sheet is unwound directly from a coil of economical ductile steel and is guided through a progressive composite tool. The pin shaft is first produced as a tube 4b in that a cup or bowl 10 having a greater diameter is drawn into the starting sheet and thus a tube 4b having a greater diameter and greater length is formed. Subsequently, the length and diameter of a tube 4b formed in this manner is reduced by deformation or swaging, accompanied by increase of its wall diameter, for which purpose a die acts upon the tube in a plurality of process steps.

The production of the pin 4 can be effected in a plurality of deep drawing processes, e.g. twelve to sixteen such processes. FIG. 5 shows very schematically an axial section during such a deep drawing process. The starting sheet 11 is received on a matrix or die 12; in the individually deep drawing processes, respectively defined in the direction R1, the cup or bowl 10 is drawn through the starting sheet 11. To prevent a thinning out of the wall of the tube 4b, follow-up means 14 are preferably provided that release material for the tube wall in the direction R2, so that a defined wall thickness d is achieved.

After completion of the pin 4, the attachment region 3 is produced by one or more further process steps, whereby, for example, a single deep drawing process can be sufficient.

The internal thread 9 in the hole 4a of the tubular pin 4 can already be formed by roll formation in the shaping tool, or also subsequently by thread cutting.

The support pin components 2 formed in the sheet strip unwound from the coil are finally cut off from the tool in the last step. Subsequently, the flanges 5 can optionally be provided in the event that such flanges have not already been formed in the starting sheet.

The support pin component 2 is thus monolithically produced, and has no weld seams. The starting sheet can have a thickness of e.g. 2.5 mm.

1-21. (canceled)

22. A method of producing a support pin component that is adapted to be attached to a reclining part of a vehicle seat and is adapted to be inserted into a support receiver of a seat frame, the method including the steps of:
providing the support pin component with an attachment region configured for attachment to the reclining part of a vehicle seat,
providing the support pin component with a pin configured for pivotable insertion into a receiver of a seat frame, and
producing the support pin component as a shaped part of sheet steel.

23. A method according to claim 22, wherein said producing step comprises producing the support pin component as a monolithic shaped part by cold deformation or shaping of sheet steel.

24. A method according to claim 22, wherein said producing step comprises shaping or deforming sheet steel in a plurality of successive process steps.

25. A method according to claim 24, wherein a starting sheet is shaped in a progressive composite process.

26. A method according to claim 25, which includes the step of pushing said starting sheet through a progressive composite tool and shaping said starting sheet in successive shaping steps until the shape of the support pin component is achieved.

27. A method according to claim 25, which includes the step of initially forming a shaft of the pin as a tube by drawing a cup or bowl into said starting sheet.

28. A method according to claim 27, which includes the further steps of:
initially drawing the cup or bowl into said starting sheet in such a way that a first tube is formed having a greater diameter and a greater length than a tube of a subsequent pin, and
subsequently reducing the length and the diameter of the first tube by swaging, accompanied by an increase in a wall thickness of said first tube.

29. A method according to claim 28, which includes the step of carrying out said swaging in a plurality of process steps by causing a die to act upon said tube.

30. A method according to claim 27, which includes the step of forming said tube by shaping said starting sheet between said cup or bowl and a matrix in a plurality of deep drawing processes.

31. A method according to claim 30, which includes the step of increasing the wall thickness of said tube by releasing material in an axial direction.

32. A method according to claim 27, which includes the steps of first forming the pin, and then forming the attachment region by at least one process step.

33. A method according to claim 32, wherein to form the attachment region, at least one deep drawing process is carried out.

34. A method according to claim 25, which includes the steps of directly unwinding sheet steel from a coil as said starting sheet, and shaping the sheet steel.

35. A method according to claim 34, which in a final shaping operating step includes the step of separating the produced support pin component from a sheet strip.

36. A method according to claim 22, which includes the further step of forming an internal thread in the pin.

37. A method according to claim 36, wherein the internal thread is already formed in a shaping tool by roll formation, or wherein the internal thread is formed subsequent to a shaping process by thread cutting.

38. A method according to claim 22, which includes the step of forming at least one laterally projecting flange on an underside of the attachment region for a laser welding to a reclining part.

39. A method according to claim 38, wherein said at least one flange is formed in a starting sheet during a shaping process.

40. A method according to claim 38, wherein said at least one flange is attached or provided after a shaping process.

41. A support pin component produced by the method of claim 22.
